(19) United States
(12) Patent Application Publication
(10) Pub. No.: US 2001/0025261 A1
(43) Pub. Date: Sep. 27, 2001

(54) Method and apparatus for providing a virtual tour of a dormatory or other institution to a prospective resident

(76) Inventor: Shari Olefson, Ft. Lauderdale, FL (US)

Correspondence Address: John G. Posa, Esq., Gifford, Krass, Groh, Sprinkle,, Anderson & Citkowski, P.C., 280 N. Old Woodward Ave., Suite 400, Birmingham, MI, 48009, US

(21) Appl. No.: 09/789,577

(22) Filed: Feb. 22, 2001

Related U.S. Application Data
(63) Continuation-in-part of application No. 08/664,164, filed on Jun. 14, 1996.
(60) Provisional application No. 60/183,912, filed on Feb. 22, 2000.

(51) Int. Cl. G06F 17/60

(52) U.S. Cl. 705/27

(57) ABSTRACT

Prospective resident of a dormitory or other institution are provided with a panoramic, interactive tour which can be viewed via CD ROM, disk, print and/or on-line via the Internet and/or Extranet and/or other network. The tour is filmed on-site at each institution providing the service. The tour database can be arranged via school(s) and/or via geographic location(s) and/or via other selection criteria. Schools will preferably send a disk with the tour of each of its dormitories to all freshmen along with the registration materials so that they can actually see each dormitory before making their housing selection. By clicking on the front door the student will enter the lobby and can likewise enter all common areas, hallways, and a sample of each room type by clicking on hotspots. A floor plan with a perspective indicator will be present. There are several alternative ways to change perspective including, without limitation, clicking on the word/icon/picture for another room or direction, click and drag, using keyboard keys, clicking on certain keys, rapid clicking on the mouse and/or voice commands. This enables the viewer to control the tour including, without limitation, to zoom in, zoom out, look/move left, look/move right, move forward or backwards. The tour can also be put into self operating mode where it can be watched as a “movie” with less interaction. The tours can be viewed in monitor or with VR goggles and/or gloves. The screen size can be changed and reconfigured. Optional audio can be accessed with options that include, without limitation, celebrity tour, current student input, local information and others.

### REFERENCE TO RELATED APPLICATION

This application claims priority from U.S. Provisional Patent Application Ser. No. 60/183,912, filed Feb. 22, 2000, and is a continuation-in-part of U.S. patent application Ser. No. 08/664,164, filed Jun. 14, 1996, the entire contents of both applications being incorporated herein by reference.

### FIELD OF THE INVENTION

This invention relates generally to computer animation and, in particular, to methods and apparatus for generating, selecting and viewing visual representations of college dorm rooms and other institutions and amenities, thereby enabling a prospective resident or visitor to “tour” the premises without a physical visitation.

### BACKGROUND OF THE INVENTION

The most difficult challenge facing college and university freshmen is the transition from living at home to living at school. Freshmen are mailed an enrollment package containing course registration and dormitory selection materials. Dormitory information is typically limited to the number of students per room and the number of rooms in each building. Seldom are students actually able to see and/or recall a dormitory they may have visited during a campus tours. Consequently, making a knowledgeable decision is difficult, thereby adding to the anxiety and “unknowns” involved in going away to school.

Another challenge involves meeting immediate needs once freshmen arrive at their selected dormitory. These needs include bedding, desk and floor lamps, window treatment, small appliances, mirror(s), decorations, etc. All of this confusions occurs at a time when freshmen are deeply absorbed with the emotional stress and time demands of school orientations, getting to know an entirely new set of friends, sorority/fraternity rushing, learning their way around campus and attending classes.

In most instances, freshmen have limited means of transportation and are completely unfamiliar with the roads and areas. In short, freshmen have no time, no way to get to and no idea where to find stores in which to purchase these immediate needs, no less shop for their favorite brands or colors or for the best prices.

### SUMMARY OF THE INVENTION

The subject invention provides a prospective resident of a dormitory or other institution with panoramic, interactive tour which can be viewed via CD ROM, disk, print and/or on-line via the Internet and/or Extranet and/or other network. In the preferred embodiments, the tour is 360-degree, spherical, an/or stereoscopic.

The tour is filmed on-site at each dormitory at each school providing the service. The tour database can be arranged via school(s) and/or via geographic location(s) and/or via other selection criteria. Schools will preferably send a disk with the tour of each of its dormitories to all freshmen along with the registration materials so that they can actually see each dormitory before making their housing selection.

A tour can be filmed and subsequently viewed in any sequence, but will typically begin with a view of the front of the dormitory. By clicking on the front door the student will enter the lobby and can likewise enter all common areas, hallways, and a sample of each room type by clicking on hotspots. A floor plan with a perspective indicator will be present. There are several alternative ways to change perspective including, without limitation, clicking on the word/icon/picture for another room or direction, click and drag, using keyboard keys, clicking on certain keys, rapid clicking on the mouse and/or voice commands. This enables the viewer to control the tour including, without limitation, to zoom in, zoom out, look/move left, look/move right, move forward or backwards. The tour can also be put into self operating mode where it can be watched as a “movie” with less interaction.

The tours can be viewed in monitor or with VR goggles and/or gloves. The screen size can be changed and reconfigured. Optional audio can be accessed with options that include, without limitation, celebrity tour, current student input, local information and others.

### BRIEF DESCRIPTION OF THE DRAWINGS

FIG. 1 is a pictorial representation of apparatus applicable to the invention;

FIG. 2 is a view of a displayed panoramic visual image where a dorm room is depicted with the user's perspective indicated on the graphical representation;

FIG. 3 is a pictorial representation of the preferred apparatus for creating the panoramic visual images; and

FIG. 4 is a screen display showing certain preferred options associated with an internet-based implementation of the invention.

### DETAILED DESCRIPTION OF THE INVENTION

As discussed in the Summary, above, this invention provides prospective residents of college dormitories with an interactive tour of the premises and available amenities that can be viewed using a high-capacity storage medium such as a CD-ROM or DVD, or on-line via the Internet, extranet or other network. The following detailed description will also concentrate on use of the invention in conjunction with college students wishing to tour a dormitory without need for a physical visit. However, it will be appreciated by those of skill that the invention may be used in other situations, particularly those in which a prospective visitor or resident wishes to select a particular institution from among a number of choices that would otherwise require a physical visit, such as condominium communities, apartment complexes, nursing homes, hospices, summer camps, prep schools, assisted-living facilities, builder homes and rehabilitation centers.

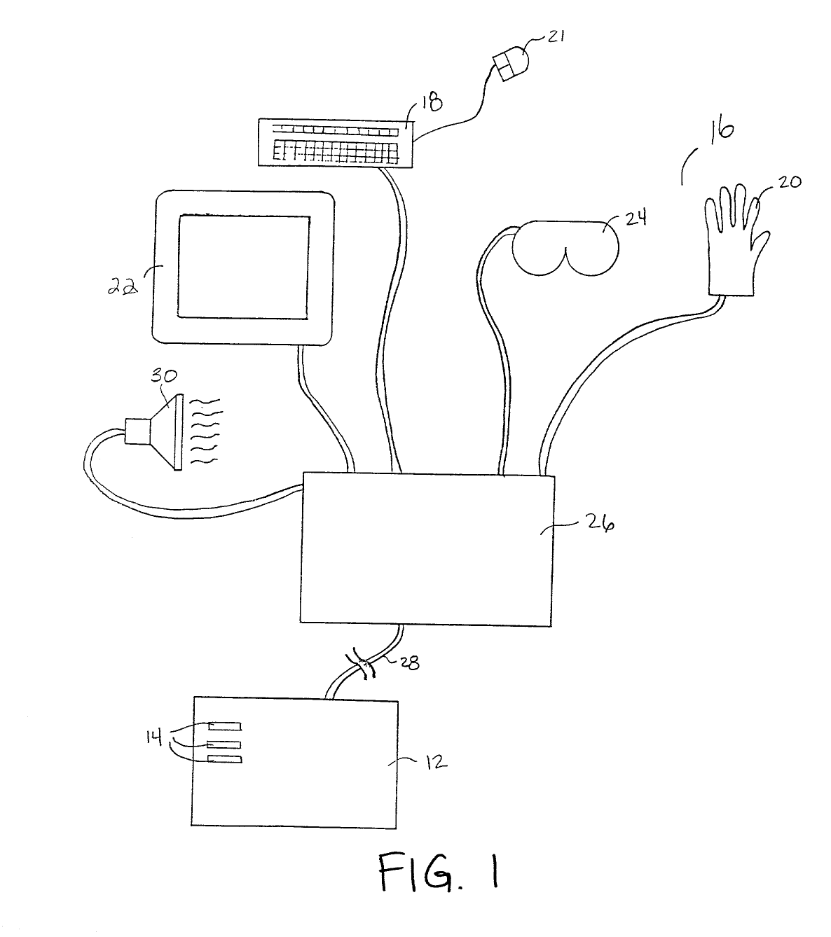

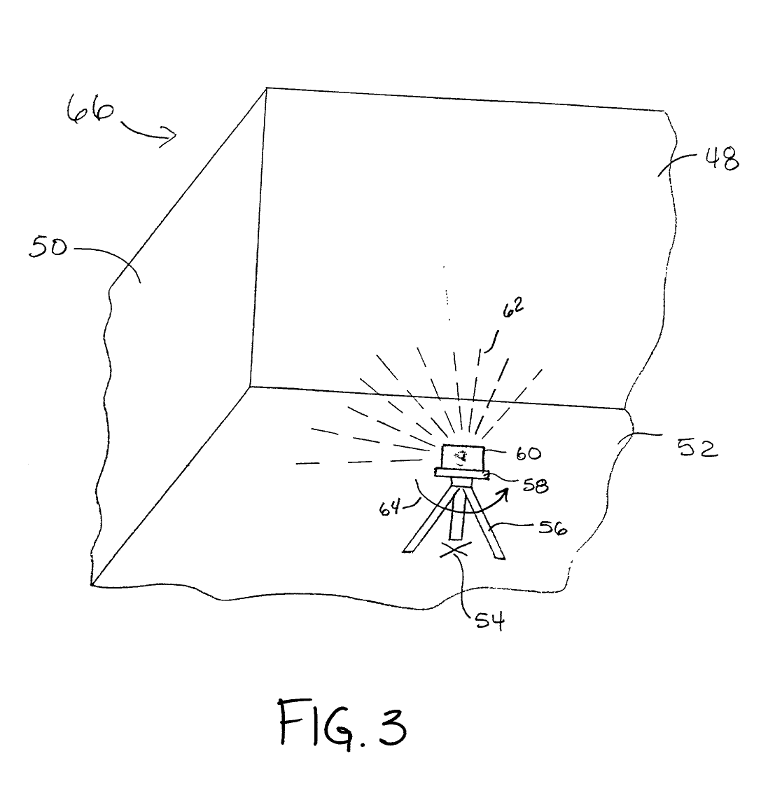

Hardware associated with an apparatus aspect of the invention is shown generally at 10 in FIG. 1. The system includes a database storing a set of panoramic visual images recorded from a particular perspective or camera position to provide a 360° panoramic “tour” of the dorm. For example, such panoramic visual images may be taken from a perspective within particular rooms of a dormitory, within the hallway, bathrooms, cafeteria rooms and so forth. Panoramic visual images of the exterior of the dorm may be taken from a perspective on the street, from a parking lot, etc. As depicted in FIG. 3, position 54 represents the perspective of the camera 60.

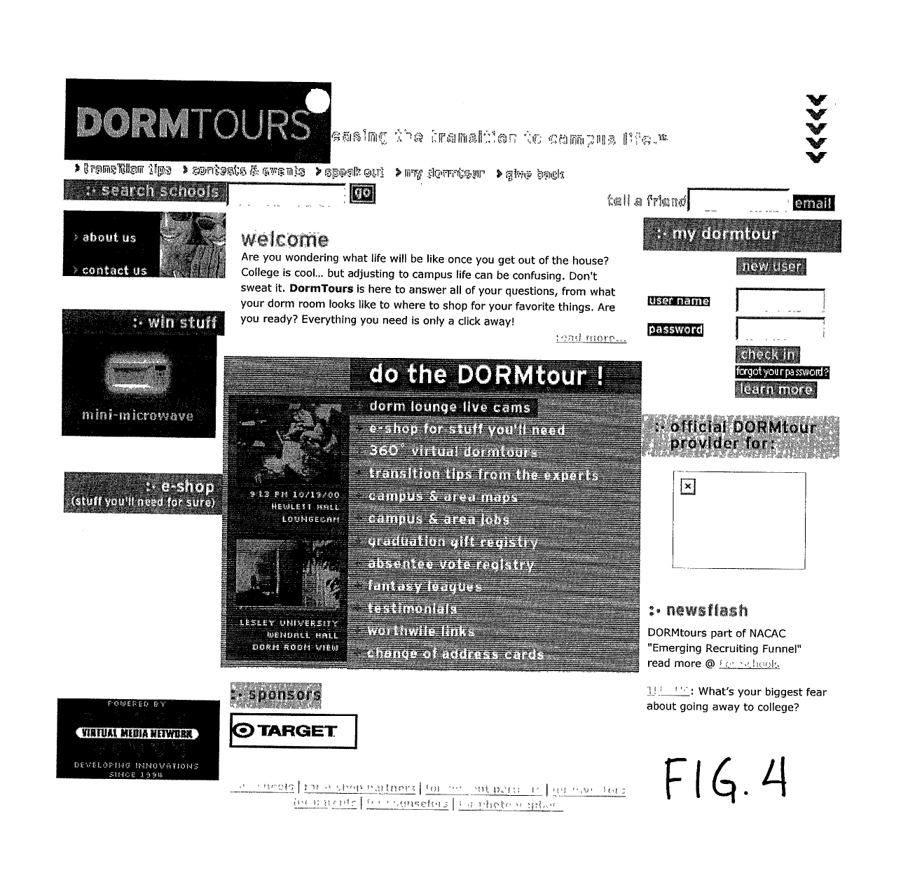

The panoramic visual images may be created in a variety of ways, the preferred embodiment being depicted in FIG. 4, which shows a portion of a dorm room 66 having a rear wall 48, a left wall 50, and a floor 52. A camera 60 having a wide angle lens (not shown) is mounted on rotating bracket 58, which is rotatably mounted to tripod 56. Bracket 58 enables camera 60 to be rotated on tripod 56 and ensures stability, levelness and consistency of angles at which the images are taken.

Camera 60 is rotated in the direction of arrow 64 at a standard increment of degrees, such as 10, 15, or 28° after recording an image until a series of photographs encompassing a full 360° are taken. Alternate embodiments may utilize a stepper motor in place of bracket 58 or utilize a rotatable tripod to automatically rotate the camera. The film from the camera is developed into a series of images and scanned. Alternatively, a digital camera may be used without the need for scanning.

As an option, software such as Adobe Photoshop may be used to manipulate and color-correct the images to produce more pleasing panoramic visual images, to remove undesired imperfections, or to adjust lighting levels and make additional modifications to the photographs rendering them clearer or cleaner. A debabelizer may also be used to reduce the color pallet across all photographs which will be stitched into a single panoramic visual image, thereby reducing the file size and increasing visibility and clarity of the image.

The images are then ‘stitched’ together to create a single panoramic visual image. A variety of software programs are available to stitch the images together to create a 360° panoramic visual image. In an alternate embodiment, a panoramic camera may be utilized to record the images which may then be digitized, eliminating the need to ‘stitch’ images together to create a single panoramic visual image.

The panoramic visual images are arranged in sets 14 in database 12. Depending upon the embodiment, database 12 may represent a removable high-capacity store medium such as a CD-ROM or DVD. In alternate embodiments, the system may be in network communication with the Internet, extranet or other network such that the sets of panoramic visual images 14 may be downloaded directly into database 12, without use of a separate or removable storage medium.

Another alternate embodiment of the invention utilizes stereoscopic or three-dimensional images, which are produced by recording two images, a “left” image corresponding to the view as seen by a user's left eye, and a “right” image corresponding to the view as seen by a user's right eye. When the “right” image is displayed to the right eye, and the “left” image is displayed to the left eye, the images are perceived stereoscopically. The images are displayed to the respective eyes through goggles, thereby permitting the user to view the panoramic visual images stereoscopically. Alternatively, the images may be viewed stereoscopically through glasses having a left lens which permits the left eye to view only the left image, and having a right lens which permits the right eye to view only the right image.

A personal computer 26 is in electrical communication via cable 28 with database 12. The PC 26 includes input means such as a standard keyboard 18, mouse 21 or voice activation means (not shown). PC 26 also has display means, such as screen 22. If screen 22 incorporates “touch screen” technology, screen 22 may be utilized as both input and display means. If the panoramic visual images were created so as to enable stereoscopic viewing, goggles 22 may be utilized to display the stereoscopic images, and glove 20 may be utilized as input means.

Using the input means, a user may input a “change perspective” command, which causes CPU 26 to display an additional image which corresponds to the new perspective requested by the user. The preferred embodiment includes change perspective commands such as look left, look right, look forward, look behind, look up, look down, zoom in and zoom out, as well as commands such as walk down hallway, go to cafeteria, and so forth. Change perspective commands enable a user to “look around” a room within a dorm, and perhaps move into other rooms, as in the case of a suite.

If the user inputs a change perspective command such as “look left,” an additional portion of the currently displayed panoramic visual image is displayed. If the user is viewing a panoramic visual image of the exterior of the dorm, and inputs a change perspective command such as “move to common area” the panoramic visual image which corresponds to the common area or meeting rooms will be displayed.

In the preferred embodiment, change perspective commands such as “look left” or “look right” may be input by moving a mouse to the left or right. Change perspective commands such as “zoom in” or “zoom out” are input utilizing the up and down arrow keys on a keyboard. Alternatively, icons may be presented to the user which represent various change perspective commands. Clearly, each change perspective command may be input in a variety of ways which are acceptable in the present invention.

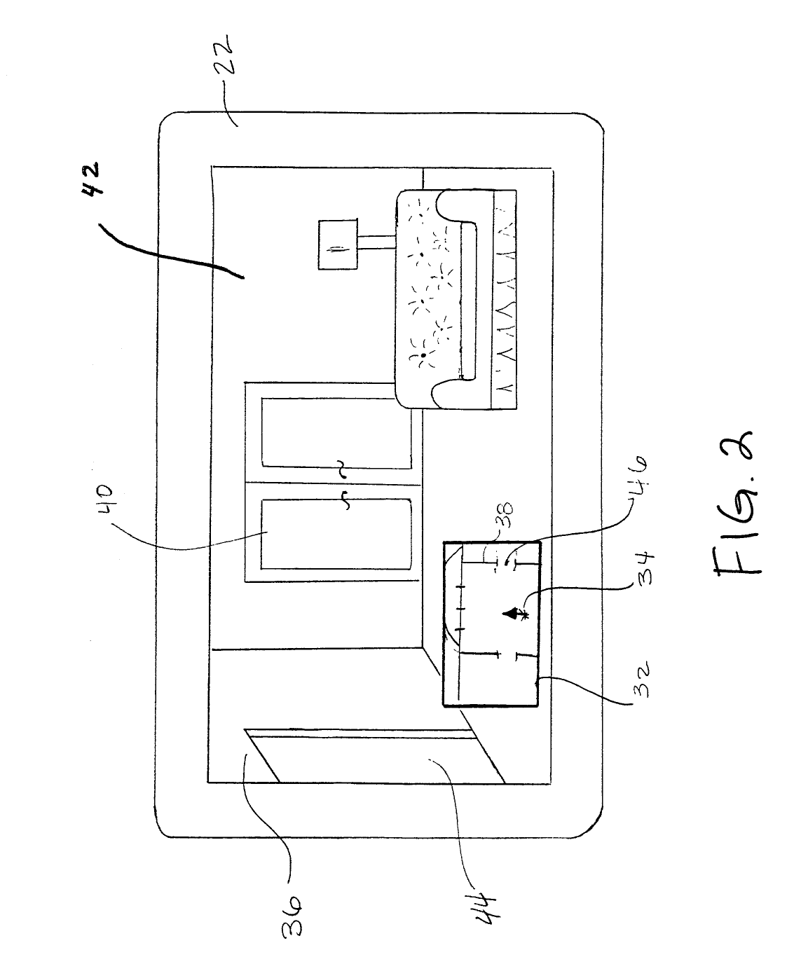

FIG. 2 shows a portion 36 of a panoramic visual image of a dorm room on display screen 22. The user in this case is looking toward the doors 40 on the rear wall 42. An exit 44 is positioned on the user's left, and, to the right of the user is exit 46 which is not displayed in the portion 36 of the panoramic visual image on screen 22. Exit 46 is shown on floor plan 38, so that the user clearly understands their position within the home and the surrounding features which are not currently displayed on screen 22. As shown in FIG. 2, the camera was positioned where indicator 32 is positioned within that room of the home, and was facing rear wall 42 when the portion 36 of the panoramic visual image was recorded.

The viewing may additionally includes an audio recording of a message the user will hear upon entering a particular room. As the user views any given panoramic visual image, an audio recording heard via speaker 30 will describe the image the user sees. For example a panoramic visual image displaying a unique aspect of the dorm, such as placement of network or electrical outlets, placement of heating vents, and so forth.

Depending upon the application, the user may request they be provided with a printout and graphic information about the room or institution. For example, a financial calculation may be provided giving the prospective occupant the standard tuition, room rate with or without a meal plan, and other financial information necessary to make an intelligent decision. A worksheet, which may be stored in the centralized data base 12, may be displayed on the display means. Of course, if the system is being used to acquaint the user with a room already reserved, such worksheet calculations may be unnecessary.

In the preferred embodiment of the invention, the user accesses database 12 via a network such as the World Wide Web. In addition to personal computers, users may optionally access the network at cafes or public locations such as kiosks in a school commons or library. FIG. 4 is a screen display showing certain preferred options associated with an internet-based implementation of the invention. A map of the campus is also preferably provided showing the location of each dormitory as well as other information about each dormitory such as number of rooms, number of students, student profiles, on-site eateries, laundry etc.

In addition to the features described, a more comprehensive embodiment may include the following:

*An “Open House” function involving live cameras positioned at each dormitory common area which operate either always or during pre-set times so that freshmen can get a feel for the students and activity in each dormitory.

*An “Interior Design” function involves showing room dimensions and typical furniture dimensions and allowing the viewer to design a layout.

*A link to related topic sites, current student chat room, or e-mail addresses of other students and/or professors

The cost of tours according to the invention may be subsidized by local, regional, and national companies. As such, tours may incorporate sponsor advertising and various options for the viewer to place orders/make purchases with/from sponsors. For example, by clicking an icon, the student can fill out an application for a credit card and e-mail, fax, or mail it. A home furnishing store sponsor might offer a preset package for each room type which the viewer can order in advance the same way. The tour will also incorporate a map of the area depicting the dormitory location and the location of all sponsors.

Generally speaking, this invention will increase the comfort level and reduce the stress of freshman and other entering institutions by allowing them to make knowledgeable decisions about their housing and by eliminating some of the “unknowns.” Freshmen will know what to expect when they actually see their new home in person for the first time and will be allowed the opportunity to purchase the above referenced immediate needs in advance so that those items can be waiting for them in their new home when they arrive.

I claim:

1. A method of providing a prospective resident of an institution with a virtual tour of the premises without the need for a physical visit, the method comprising the steps of:
recording a set of panoramic visual images for each of a plurality of institutions to be selected and viewed, each panoramic visual image being recorded from a particular perspective;
storing the sets of panoramic visual images and accompanying unique designations in a computer database along with an index of selection criteria, such criteria including the location and physical features of each institution;
providing a user terminal in electrical communication with the centralized computer database, the terminal including input means and a display device; entering, through the input means of the user terminal, one or more criteria associated with an institution to be toured;
displaying one of the panoramic visual images stored for the selected institution on the display device;
receiving a change perspective command through the input means of the user terminal; and
displaying an additional panoramic visual image for the selected institution in accordance with the change perspective command.

2. The method of claim 1, wherein the institution is a dormitory.

3. The method of claim 1, wherein the panoramic images encompass a 360-degree field of view.

4. The method of claim 1, wherein the panoramic images encompass a spherical field of view.

5. The method of claim 1, wherein the panoramic images are stereoscopic.

6. The method of claim 1, wherein the user accesses the database over the internet or other computer network.

7. The method of claim 1, further including the step of providing an open house function wherein live cameras are positioned at one or more common areas, and wherein the cameras are operated so that prospective residents can get a feel for the level of activity at the institution.

8. The method of claim 1, further including the step of providing an interior design function showing room dimensions and typical furniture dimensions enabling the viewer to design a layout.

9. The method of claim 1, further including the step of providing a link to related topic sites, chat room(s), or e-mail addresses.

10. The method of claim 1, further including the step of providing an audio accompaniment to the virtual tour.

11. The method of claim 10, wherein the audio accompaniment includes a celebrity tour, current student input, or local information.
